(19) United States
(12) Patent Application Publication
(10) Pub. No.: US 2011/0223343 A1
(43) Pub. Date: Sep. 15, 2011

(54) NOVEL NANOCOMPOSITE FOR SUSTAINABILITY OF INFRASTRUCTURE

(75) Inventors: Jialai Wang, Tuscaloosa, AL (US); Xinyu Zhang, Auburn, AL (US)

(73) Assignees: AUBURN UNIVERSITY, OFFICE OF TECHNOLOGY TRANSFER, Auburn, AL (US); The University of Alabama Office for Technology Transfer, Tuscaloosa, AL (US)

(21) Appl. No.: 13/038,205

(22) Filed: Mar. 1, 2011

Related U.S. Application Data
(60) Provisional application No. 61/309,262, filed on Mar. 1, 2010.

(51) Int. Cl. B01J 19/10; B05D 7/00; B82Y 40/00

(52) U.S. Cl. 427/457; 427/215; 977/890

(57) ABSTRACT

A nanocomposite has significant social, economic and environmental benefits. By having high tensile strength and high toughness, a large number of opportunities of applying fly ashes are opened up. Besides replacing ordinary Portland cement, the nanocomposite is able to be used as an inorganic adhesive/resin to make fiber reinforced inorganic composites. The composite is fire resistant and has no volatile organic compounds. Due to its multifunctional character, the nanocomposite is able to be used as a sensing element in intelligent structures, corrosion protection coating for concrete and steel structures and even electronic devices.

### CROSS-REFERENCE TO RELATED APPLICATION(S)

This application claims priority under 35 U.S.C. §119(e) of the U.S. Provisional Patent Application Ser. No. 61/309,262, filed Mar. 1, 2010 and titled, “A NOVEL GEOPOLYMERIC NANOCOMPOSITE FOR SUSTAINABILITY OF INFRASTRUCTURE.” The Provisional Patent Application Ser. No. 61/309,262, filed Mar. 1, 2010 and titled, “A NOVEL GEOPOLYMERIC NANOCOMPOSITE FOR SUSTAINABILITY OF INFRASTRUCTURE,” is also hereby incorporated by reference in its entirety for all purposes.

### GOVERNMENT LICENSE RIGHTS

The U.S. Government has a paid-up license in this invention and the right in limited circumstances to require the patent owner to license others on reasonable terms as provided for by the terms of Contract/Grant No. 1000491 and 1000580 awarded by NSF on May 1, 2010.

### FIELD OF THE INVENTION

The present invention relates to the field of nanocomposites. More specifically, the present invention relates to carbon nanotubes for sustainability of infrastructure.

### BACKGROUND OF THE INVENTION

Ordinary Portland cement (OPC)-based concrete is the most widely used construction material. The global use of concrete is only second to water, accounting for 70% of all building and construction materials. OPC has two inherent drawbacks: large amount of green house gases emission and susceptibility to deterioration in severe environments. There is a big concern about the sustainability and environmental impact of construction materials.

A number of new materials, which could replace OPC, have been investigated. The materials include magnesia cement, sulfoaluminate cements, blended OPC-based cements and geopolymers.

Geopolymers are amorphous three-dimensional alumino-silicate binder materials. They are able to be synthesized by mixing source material with an alkaline activator and then curing at room or elevated temperature. The source materials based on alumina-silicate are rich in silicon and aluminum, and are able to be natural minerals such as clay, kaolinite or industrial wastes such as fly ash, silica fume or slag. The alkaline activators are strong chemical bases. The most commonly used activator is the combination of NaOH or KOH with Sodium silicate or Potassium silicate. Aluminosilicate reactive materials are rapidly dissolved into the strong alkaline solution to form free SiO₄ and AlO₄ tetrahedral units. These SiO₄ and AlO₄ are then polymerized together to form polymeric precursors (—SiO₄—AlO₄—, or —SiO₄—AlO₄—SiO₄ or —SiO₄—AlO₄—SiO₄—SiO₄—) by sharing all oxygen atoms between two tetrahedral units, and thereby yielding amorphous geopolymers. A hydrated geopolymer has the following empirical formula: Mₙ{—(SiO₂)_{z}—AlO₂}ₙ.wH₂O, where n is the degree of polycondensation; z is 1, 2 or 3 and M is a cation such as potassium, sodium and w is the number of water molecules in the hydrate.

Carbon nanotubes (CNTs) have drawn a great deal of attention since Iijima discovered this new class of allotrope of carbon. Due to its extraordinary mechanical, thermal and electrical properties, CNTs have huge potential in the applications of composite materials, smart structures, chemical sensors, energy storage and nano-electronic devices. However, the challenges remain in the high cost of CNT raw materials and the difficulty in its processing and applications. For example, vacuum or inert gas protection, high temperature and/or high energy density are needed for the production of CNT, e.g., arc-discharge, laser ablation and chemical vapor deposition (CVD) approaches, which make the cost of as-produced CNT high. In addition, strong van der Waals force induced poor solubility/dispersibility is another factor that restricts the application of CNT, especially in reinforcing composite materials.

As an attempt to address the challenges mentioned above, some reports discussed to embed CNT into carbon fibers through conventional thermal heating process, and CVD methods, which are able to partially solve the dispersibility issue, but the reaction setup is still costly and complicated, and the process is time-consuming and energy inefficient due to the target-less volumetric heating.

### SUMMARY OF THE INVENTION

A nanocomposite has significant social, economic and environmental benefits. By having high tensile strength and high toughness, a large number of opportunities of applying fly ashes are opened up. Besides replacing ordinary Portland cement, the nanocomposite is able to be used as an inorganic adhesive/resin to make fiber reinforced inorganic composites. The composite is fire resistant and has no volatile organic compounds. Due to its multifunctional character, the nanocomposite is able to be used as a sensing element in intelligent structures, corrosion protection coating for concrete and steel structures and even electronic devices. Besides the construction industry, many other industries, such as aerospace and automotive, are also able to benefit by using the nanocomposite.

In one aspect, a method of generating a nanocomposite comprises coating a material with conducting polymers, coating the resultant material coated with conducting polymers with a catalyst precursor and performing irradiation to generate carbon nanotubes on the material to form a nanocomposite. The irradiation is microwave irradiation. The material is selected from the group consisting of fly ash particles, ordinary Portland cement, metakaolin, micron-sized glass balls and ground tire rubber particles, slag particles, glass fibers, carbon fibers, Kevlar fibers and Basalt fibers. The catalyst precursor is ferrocene. Poptube precursors are prepared by decorating the catalyst precursor on stand-alone conductive materials or conductive materials coated with engineering materials. The conductive materials comprise carbon fibers. The conductive materials are selected from the group consisting of ITO powders and polypyrrole.Cl powder and polypyrrole.Cl coated fly ash powders, glass fibers, Kevlar, Basalt fibers or microballoons. Performing irradiation takes 5-15 seconds. Performing irradiation occurs at ambient temperature. The nanocomposite is filled in a polymer matrix.

In another aspect, a method of generating a nanocomposite comprises blending fly ash particles coated with carbon nanotubes with fly ash particles without carbon nanotubes to form a blended source material, mixing the blended source material with an alkaline activator which results in a nanocomposite and molding the nanocomposite into a desired shape. The method further comprises coating the fly ash particles with the carbon nanotubes to form coated fly ash particles.

In yet another aspect, a method of generating carbon nanotubes comprises decorating a catalyst precursor on conductive materials and heating the decorated catalyst precursor and the conductive materials, wherein the catalyst precursor decomposes to an iron catalyst and cyclopentadienyl which serves as a carbon source. Heating comprises microwave irradiation. Heating includes heating to a temperature above 1100° C. The catalyst precursor is a metallocene. The catalyst precursor is ferrocene. The conductive materials are coated with a nanocomposite. The carbon source is used to generate carbon nanotubes.

In another aspect, a method of generating carbon nanotubes comprises positioning a precursor, mixing a conductive polymer with the precursor and microwave irradiating the precursor and the conductive polymer mixture to generate carbon nanotubes. The conductive polymer is selected from the group consisting of conductive polypyrrole.Cl powder or film and ITO nanopowder. Microwave irradiating takes 5-15 seconds. Microwave irradiating occurs at ambient temperature.

In yet another aspect, a method of generating a nanocomposite comprises coating particles with conducting polymers, coating the resultant particles coated with conducting polymers with a catalyst precursor and performing irradiation to generate a metal oxide on the particles to form a nanocomposite. The irradiation is microwave irradiation. The particles are selected from the group consisting of fly ash, ordinary Portland cement, metakaolin, micron-sized glass balls and ground tire rubber particles, slag particles, glass fibers, carbon fibers, Kevlar fibers and Basalt fibers. The catalyst precursor is zinc chloride. Performing irradiation takes 5-15 seconds. Performing irradiation occurs at ambient temperature. The nanocomposite is filled in a polymer matrix. The metal oxide is selected from the group consisting of Titanium Oxide, Zinc Oxide or Silicon Oxide.

### BRIEF DESCRIPTION OF THE DRAWINGS

FIG. 1 illustrates a method of using microwave irradiation to grow carbon nanotubes on the surface of fly ash according to some embodiments.

FIG. 2 shows SEM images of granular PPy.Cl, CNTs grown on PPy.Cl granules, ITO nanopowder, CNTs grown on ITO nanopowders and a TEM image of an individual CNT grown on ITO nanopowders according to some embodiments.

FIG. 3 shows a TEM image of CNTs grown on PPy.Cl granules and HRTEM of individual CNT with a trapped Fe catalyst according to some embodiments.

FIG. 4 shows SEM images of produced CNTs on fly ash and glass fiber fabrics according to some embodiments.

FIG. 5 illustrates a synthesis process of a nanocomposite according to some embodiments.

FIG. 6 illustrates a schematic drawing of a scanning confocal Raman microscopy for Raman imaging and spectroscopic studies of a nanocomposite sample according to some embodiments.

FIG. 7 illustrates an applied mechanical force on a nanocomposite using a PZT patch according to some embodiments.

FIG. 8 illustrates SEM images of CNT coated Kevlar fiber, Basalt fibers, glass microballoons and carbon fibers according to some embodiments.

FIG. 9 illustrates a three point bending test according to some embodiments.

FIG. 10 illustrates an image of ZnO crystals according to some embodiments.

### DETAILED DESCRIPTION OF THE PREFERRED EMBODIMENT

An inexpensive, ecologically sound, high-performance, cement-like construction material, referred to as nanocomposite through engineering fly ash, is described herein. The composite includes a fly ash based geopolymer matrix and carbon nanotubes (CNTs). CNTs are used not only to reinforce and toughen the geopolymer matrix, but also to control the nanoscale structure of the engineering material. Besides replacing Ordinary Portland cement (OPC), the composite is able to be used as an inorganic adhesive/resin to make fiber reinforced inorganic composite. The composite is fire resistant and has no volatile organic compounds. Mechanical properties and durability of this new nanocomposite substantially surpass that of ordinary geopolymer and OPC. To avoid the difficulty of dispersion of CNTs in the engineering materials, CNTs are directly grown on the surfaces of fly ash using a microwave irradiation method. The microwave irradiation approach uses very simple equipment and is energy efficient. Due to its multifunctional character, the nanocomposite is also able to be used as a sensing element in intelligent structures, corrosion protection coating for concrete and steel structures and even electronic devices. A method is also described to measure the stress transfer between geopolymer matrix and CNTs using a Raman Spectrometer.

Compared with OPC, geopolymers possess many ‘green’ features such as high durability, recyclability and less energy consumption and CO₂ emission during manufacture, using industrial wastes, such as fly ash, as source materials.

Geopolymers also set very fast, have very high early age strength and generate a good bond with concrete, thus enabling geopolymers to be used to repair/retrofit aging infrastructure. Standard geopolymers have two drawbacks: brittleness and low tensile strength. Thus, a modified engineering material which overcomes these drawbacks is desired.

Through nanoscale reinforcing and nanoscale structure modification technology, geopolymer strength and ductility are able to be improved. CNTs are incorporated into a geopolymer matrix through nano-engineering the surfaces of source materials. The material containing the geopolymer matrix and CNTs is referred to as a nanocomposite. Fly ash is able to be used as a source material for engineering materials considering environmental benefits. In addition to enhanced strength and toughness, the nanocomposite also possesses the desirable properties of geopolymers.

Ag/carbon nanoarchitectures have been synthesized by hydrothermal metal-catalyzed carbonization, where aqueous solutions of starch and AgNO₃ are heated to 160-200° C.

Micro-sized carbon fibers are able to be synthesized from polymer precursors, for example, polyacrylonitrile fibers. As the nanostructured conducting polymers possess moderate conductivity (10⁻²˜10²Ω·m) and nanodimensions, they absorb microwave irradiation very efficiently, which makes the nanostructured conducting polymers good precursors for rapid conversion to nanocarbons. Since the enormous amount of heat is able to be generated by microwave heating conducting polymers, they are able to be used as a sacrificial heating layer to initiate carbon nanotube formation and self conversion to nanocarbons. By using the microwave irradiating method, CNTs are able to be obtained from polypyrrole.

### Microwave Irradiation

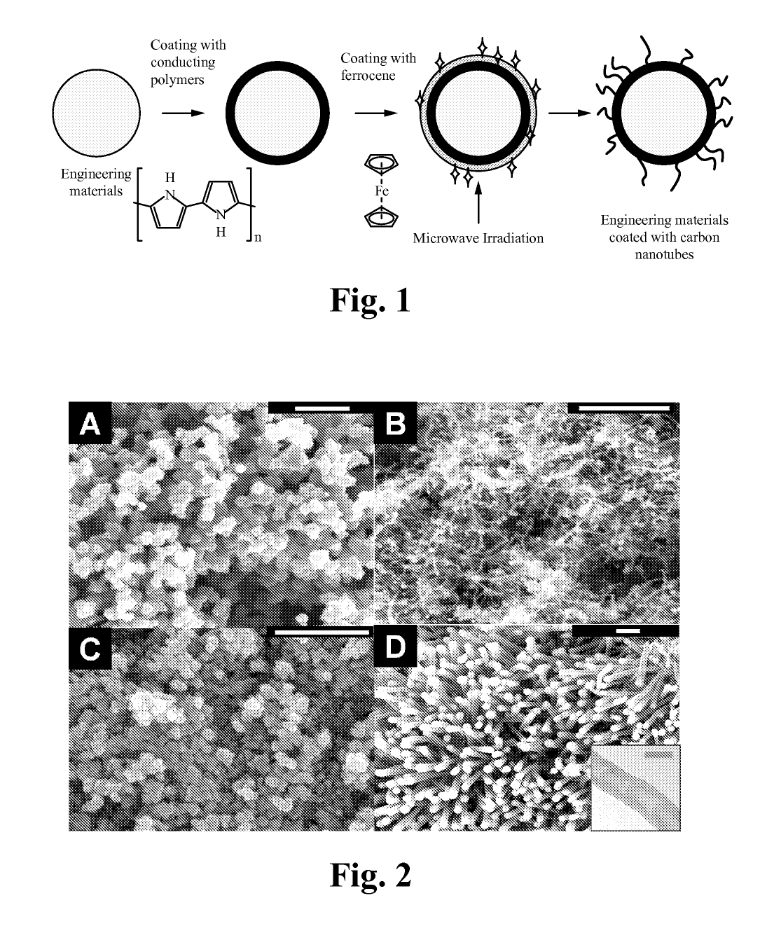

To use the microwave irradiation technique to grow carbon nanotubes on the surface of fly ash, a two-layer approach is used as shown in FIG. 1. The conducting polymers are in-situ deposited on the surfaces of fly ash particles during the polymerization process, the resultant fly ash particles coated with conducting polymers are then suspended in ferrocene solution. The ferrocene is absorbed on the surface of the conducting polymers, upon microwave irradiation, the conducting layer will absorb the microwave irradiation, and the temperature will rise up very quickly and high enough to decompose ferrocene to iron and cyclopentadienyl groups. Iron will stick on the surface of the heating layer, and serves as the catalyst. And the carbon atoms pyrolyzed from cyclopentadienyl ligand will serve as the carbon source. The source material used is low-calcium fly ash whose chemical composition is given by Table 1. The major chemical compositions of fly ash, SiO₂ and Al₂O₃, are good supporting materials for the growth of CNTs.

TABLE 1
Chemical composition of fly-ash in some embodiments.

| | chemical | | | | | |
|---|---|---|---|---|---|---|
| | SiO₂ | Al₂O₃ | Fe₂O₃ | SO₃ | CaO | Na₂O |
| content (%) | 50.38 | 27.2 | 9.16 | 0.3 | 2.49 | 0.69 |

In some embodiments, microwave Poptube precursors are prepared by decorating a catalyst precursor, for example, ferrocene, on either stand-alone conductive materials (conducting polymers, ITO powders or others) or conductive materials coated with engineering materials. In some embodiments, other metallocenes are used as catalyst precursors. Upon microwave irradiation to the Poptube precursors, the conductive materials will be heated to spark, arc and rapidly reach the temperature above 1100° C., where the ferrocene will be decomposed to iron catalyst and cyclopentadienyl, that could serve as the carbon source.

The SEM images revealed very different morphologies of the CNTs made from conductive polypyrrole.Cl powder (PPy.Cl) and ITO nanopowders as shown in FIG. 2. FIG. 2 shows SEM images of granular PPy.Cl (Image A), CNTs grown on PPy.Cl granules (Image B), ITO nanopowder (Image C), CNTs grown on ITO nanopowders (Image D) and a TEM image of an individual CNT grown on ITO nanopowders (inset of Image D) according to some embodiments. Spaghetti-like, hollow CNTs were observed (Image B in FIG. 2), when conducting PPy.Cl was used as the heating layer, with outer diameter in the range of 30-50 nm. However, rod-like CNTs with bamboo-shaped inner hollow structures were obtained when ITO nanopowders were used as the heating layer (Image D and the inset in FIG. 2), having outer diameter in the range of 150-200 nm. The nature of the conducting layers plays a significant role in controlling the morphology of the CNTs, e.g., the crystallinity and conductivity of the heating layers could affect the crystallinity and dimension of the iron catalyst nanoparticles. The multi-walled nature of the CNTs was evidenced by high resolution TEM (HRTEM) as shown in Image B of FIG. 3, confirming the CNTs are composed of ˜20 layers of coaxially folded grapheme sheets.

Besides the stand-alone conductive materials such as PPy.Cl or ITO nanopowders, these multi-walled CNTs (MWNT) are also able to grow on a variety of engineering materials, which are either pre-coated with the conductive materials or intrinsically conductive such as carbon fibers. MWNTs were successfully grown on PPy.Cl coated fly ash powders, glass fibers, Kevlar, Basalt fibers, commercial 3M glass microballoons and carbon fibers through this Microwave Initiated Poptube (MIP) approach, using ferrocene and its derivatives as the catalyst and carbon source combo. In this aspect, the Poptube approach is able to be considered as a “Universal” method due to the diversity of the surfaces on which this method is able to apply.

As described herein, an ultrafast microwave approach enables CNT growth in the air at room temperature within 5-15 seconds; CNTs are able to be directly grown on a wide selection of engineering materials including glass fibers, carbon fibers, fly ash, glass microballoons and others; the incorporation of CNT decorated glass microballoons enhances the toughness of syntactic foam. The novel Poptube approach also provides a possible solution for the existing challenges in CNT applications, such as high cost, low dispersibility and small scale production. In addition, due to the high-efficiency and selective heating of microwave irradiation, this Poptube method is able to be considered as a “green and sustainable” technology.

The microwave irradiation approach is facile, rapid, economical, and environmentally benign. Microwave heating has higher efficiency of energy transfer, compared to the traditional thermal heating methods. Since the whole process is able to be carried out in the air at room temperature within one minute, there is no need of expensive vacuum setups. Only one inexpensive chemical is employed to serve as both catalyst and carbon source, besides the fly ash substrates and conducting polymer layers for microwave absorption. The cost of CNTs obtained by this method is estimated to be much lower than any other existing methods. The method is also able to be scaled up for large volume production of CNTs, which is useful for civil engineering applications.

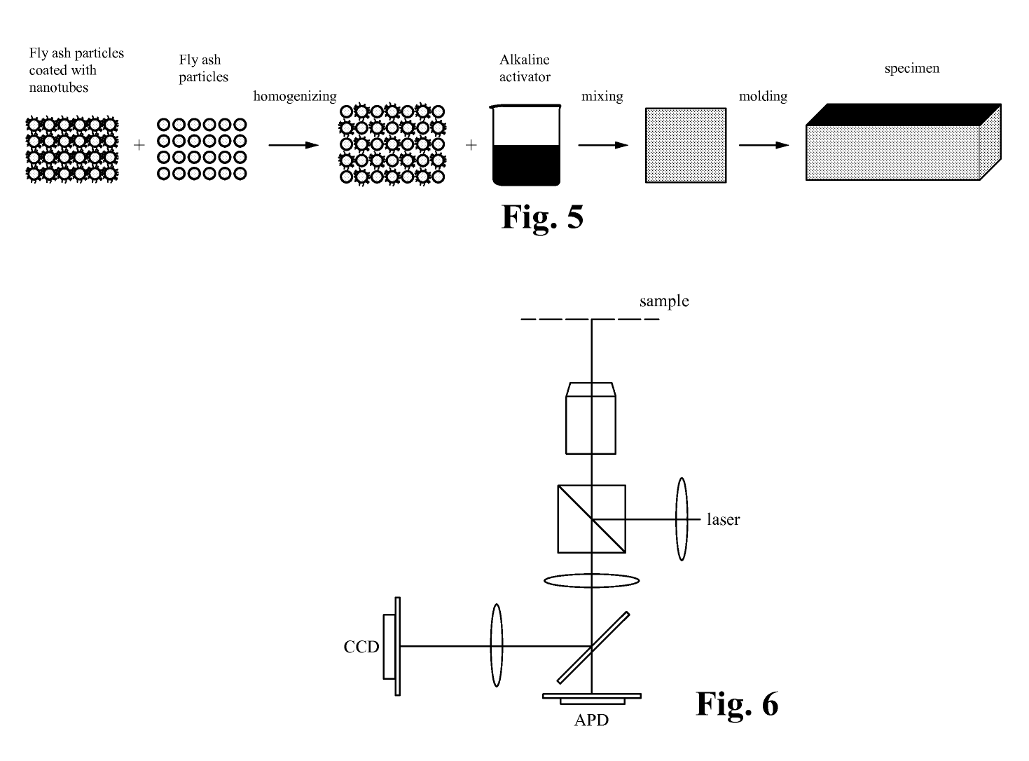

As illustrated in FIG. 5, the fly ash particles coated with CNTs are blended uniformly with fly ash particles which are not coated with CNTs. The resulted blended source materials are mixed with an alkaline activator. Once fly ash particles contact the alkaline solution, hydrolysis reaction is initiated. With the aluminate and silicate species dissolved from fly ash particles into the solution, CNTs will be liberated and dispersed homogeneously nearby the fly ash particles. After geopolymization is finished, these CNTs form a network bridging fly ash particles. Exceptional dispersion of CNTs within geopolymer matrix is able to be reached by this method. The commonly used approach to disperse CNTs, including chemically fictionalization and sonication, is totally avoided. This makes it possible to manufacture a large volume of nano composite quickly and continuously.

Although microwave heating is described as the mode of heating, other radiation-based methods are able to be used, including but not limited to, radio frequency heating. Additionally, the structure is not limited to concrete or fly ash (glass microsphere) applications. The irradiation method is able to be used to grow CNTs directly on other materials such as ordinary Portland cement particles, metakaolin particles, hollow/solid micron-sized glass balls and ground tire rubber particles. The method is also able to be used to grow CNTs on other particles (e.g. slag particles), on different fibers (e.g. glass, carbon) or on different surfaces. These particles or fibers grafted with CNTs are able to be homogeneously dispersed to make new multifunctional nanocomposites. The surfaces coated with CNTs are also able to possess multifunctionality, such as superhydrophobicity which is able to be used to develop self-cleaning coatings, ultrahigh thermal conductivity which is able to be used in thermal management, and ultrahigh absorption which is able to be used in waste water treatment. Other variations, such as different materials, are able to serve as the supporting conductive polymer layer or the catalyst solution. An affordable and scalable microwave approach for the direct growth of CNT on a wide range of substrates, including carbon fibers, glass fibers, Kevlar, fly ash, Kaolin, and Basalt fibers is described herein. The microwave initiated CNT growth will take only 5-15 seconds under the microwave irradiation at room temperature in the air, with no need of any inert gas protection and additional feed stock gases, usually required in CVD approach.

### Nanoscale Structure

Due to their numerous exposed edge planes, which provide potential sites for advantageous chemical and physical interaction with geopolymer gel, CNTs play a very important role in the formation of engineering materials through acting as the nucleating sites. It was found that the inductive period (the time taken to form stable nuclei so that geopolymer network growth can begin), which was 42 hours in regular sodium hydroxide activation of fly ash, does not exist when nanoparticles were added. Without nanoparticle seeds, geopolymer gel nucleates on the fly ash surface in hydroxide-activated geopolymers. After nanoparticles are added, geopolymer nucleates directly around the seed particles, leading to formation of a different type of zeolite in the geopolymer gel. The crystal size decreases with increasing CNTs seeds. The induction time is significantly reduced by adding a small amount of CNTs.

Certain control on reaction kinetics and nanoscale structure of geopolymers is able to be obtained by adding CNTs into a geopolymer matrix. The synthesis of the fly ash-based engineering materials is able to be accelerated in this way, which is very important because the chemical activity of fly ash is usually lower than that of metakaolin. The microstructure of geopolymers without CNTs includes amorphous nanoparticlulates separated by nanopores of several nanometers. By adding CNTs, the CNTs together with the geopolymer matrix wrapping around the CNTs becomes nano-fibrils. These nano-fibrils form a network and bridge different residual fly ash particles and other aggregates in geopolymers. Clearly, nano-fibrils have much higher tensile strength and elongation than nanoparticulates. In addition, by adjusting the concentrations and orientations of CNTs in the nanocomposite, the nanoscale structure of the engineering material composites is able to be tailored, leading to changes in the physical and chemical properties of the new nanocomposite.

### Raman Spectroscopy

Raman spectroscopy is a non-destructive spectroscopic technique used to study the vibration modes in a system. Rama spectroscopy relies on the inelastic scattering of monochromatic light, usually from a laser in the visible, near-infrared or near-ultraviolet range. The laser light interacts with quantized modes of vibration of a material, resulting in the energy of the laser photons being increased or decreased. The change in energy gives information about the vibration modes in the system. Infrared spectroscopy yields similar, but complementary, information.

A scanning confocal Raman spectrometer, as illustrated in FIG. 6, is used to conduct in-situ measurements and surface mapping of a local Raman profile in the nanocomposite paste sample. The setup is comprised of an inverted optical microscopy attached with a digital camera for bright field imaging, an Acton SP-2558 imaging spectrograph and monochromator coupled to a liquid nitrogen-cooled charge-coupled device (CCD) spectrometer for a real-time Raman spectrum acquisition. A nanopositioner and an avalanche photo diode (APD) are used for scanning and local Raman detection, respectively. For example, Raman images of fly ash particles immobilized onto a coverslip are able to be obtained. A single fly ash particle is able to be located, and its Raman profile is able to be imaged with a high spatial resolution. This setup is able to not only provide qualitative analysis but also quantitative analysis of the reaction species including reactants and products. Compared to Fourier Transform Infrared Spectroscopy (FTIR), scanning con focal Raman microscopy has the advantages of much higher sensitivity, nanometer spatial resolution and minimum sample requirement. In addition, the sample does not have to be transparent and need special treatment.

To monitor the gel formation of the nanocomposite at the early stage, fresh nanocomposite paste is poured into a transparent reaction cell with a Teflon seal. The reaction cell is then put on the sample holder of the testing setup as shown in FIG. 6. The Raman setup is suitable for a variety of time scale ranging from a few milliseconds to months. In this study, spatial mapping of local Raman profile of the nanocomposite sample is collected every five minutes for up to ten days. A spatial distribution of reactants and products and detailed reaction kinetic information of the geopolymization is able to be obtained. For example, reaction rates are able to be determined from the intensity variation of the Raman bands related to the geopolymer gel network and the unreacted fly ash particle as well as carbon nanotubes. With a nanometer spatial resolution of our Raman spectrometer, it is possible to capture a single CNT/CNF in the specimen. This allows direct monitoring of the reaction at the nucleating seeds, which is not possible by using FTIR. By using scanning confocal Raman microscopy, direct observation of this phenomenon at single fly ash particle level is possible. The setup also allows study of the orientation of CNTs in the alkali-activated complex binders because the Raman scattering is a function of relative direction of incident light and the crystal axis of a substance under investigation.

### Stress Transfer

Homogeneously dispersing CNTs in a matrix is only half of the success of nanoreinforcing. To reach the full potential of CNTs, stress should be efficiently transferred from the matrix to CNTs. However, to measure this stress transfer between the matrix and the CNTs' interface is one of the most difficult problems in the physics of nanocomposites.

A novel way to apply stress to a nanocomposite sample uniformly in any direction is illustrated in FIG. 7. First, a thin layer of the fresh nanocomposite paste is deposited on a piezoelectric patch (PZT) (FIG. 7 (left figure)) and sealed by a Teflon film. After curing, the nanocomposite and PZT patch will form a bimorph (FIG. 7 (right figure)). This bimorph is loaded on top of the scanning stage of the confocal microscopy shown in FIG. 6. Once a voltage is applied to the PZT patch, the patch will either expand or contract uniformly in all directions depending on the sign of the voltage. A uniform strain field is able to be generated in the PZT patch, which will be transferred to the attached nanocomposite. In this way, the shift of D-band with stress/strain will be much more significant, and the stress transfer between the matrix and CNTs is able to be measured more accurately. Young's modulus of CNTs is able to be estimated based on the Laman measurement as:

$${E}_{n t} = [ \frac{{d}_{31} V}{{ɛ}_{n t}} ] \frac{1 - {φ}_{n t}}{{φ}_{n t}} {E}_{m} , {ɛ}_{m} , {ɛ}_{n t} = - \frac{{ω}_{0} - {ω}_{q}}{{ω}_{q}} {E}_{m}$$

where ω₀, ω_{q} are bond frequencies before and after applied voltage, respectively; d₃₁ is the piezoelectric coefficient of the PZT patch; φₙₜ is the volume ration of CNTs; and Eₘ is the modulus of the matrix.

### Self-Sensing

Once CNTs are added into an engineering material, the resulting nanocomposite will possess multifunctions. One of the most interesting functions the new nanocomposite will possess is self-sensing. The electric resistances of CNTs change with strain/stress. The same phenomenon has been observed in CNT/polymer or CNT/cement composites. Experimental studies have shown that the electric resistance of CNT/polymer composites varies linearly with the stress/strain, which suggests that CNT/polymer composites are able to sense the strain of themselves. CNT/polymer composites are able to be used as strain sensors. Nanocomposites also have this ability.

### Experiment #1

In situ deposition of conducting polymer on fly ash:

one gram of fly ash was stirred in 60 ml of 0.2M solution of pyrrole in water. To this mixture was added 40 ml of a 0.04M solution of the oxidant ammonium peroxydisulfate, also in water. After 1 hour, the resulting dark precipitate of polypyrrole coated fly ash was suction filtered, washed with copious amounts of water and acetone and dried under a dynamic vacuum at 50° C. for 12 hours.

Microwave treatment: the polypyrrole coated fly ash is able to then be mixed well with ferrocene (preferably through a fast spinning mixer) at different weight ratio, for example a one to one ratio. Upon 10 seconds of irradiation using a standard (household) microwave, the mixture is heated up and the ferrocene is decomposed to iron catalyst and carbon source, then followed up by quick carbon nanotube growth on the fly ash surface.

### Experiment #2

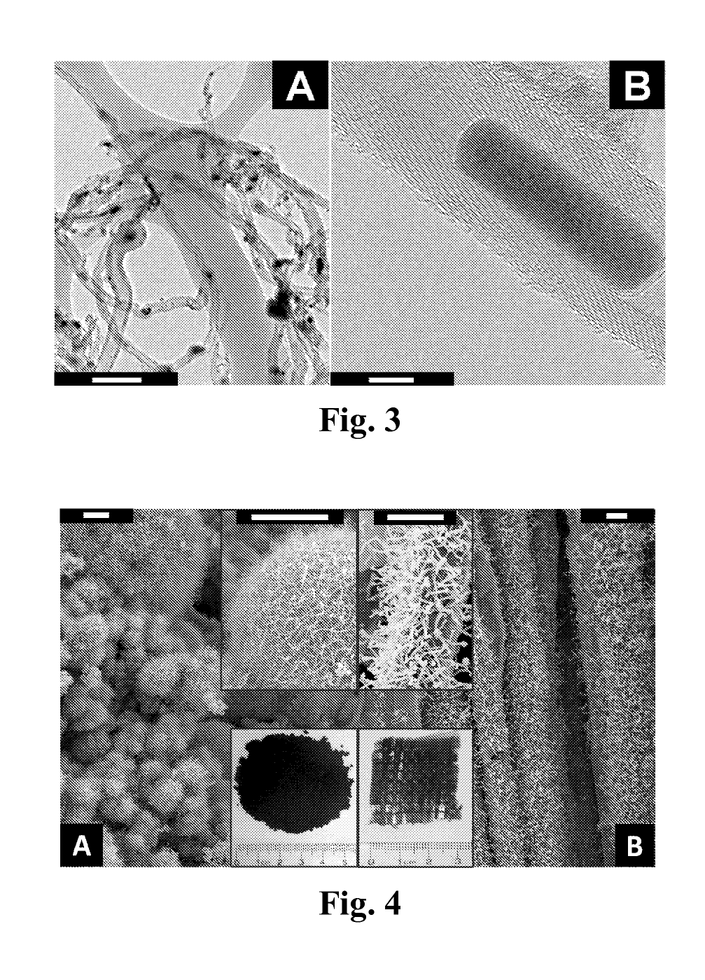

Conducting PPy.Cl coated fly ash and glass fiber cloth were selected as the substrate materials. 10 g powder of the fly ash-CNT nanocomposites is easily produced using this Poptube approach within 10 minutes in the lab (as shown in insert of image A in FIG. 4), and make CNT coated glass fiber fabrics with dimension at 1 inch×1 inch (as shown in insert of image B in FIG. 4), which depends on the size of the container in the microwave oven.

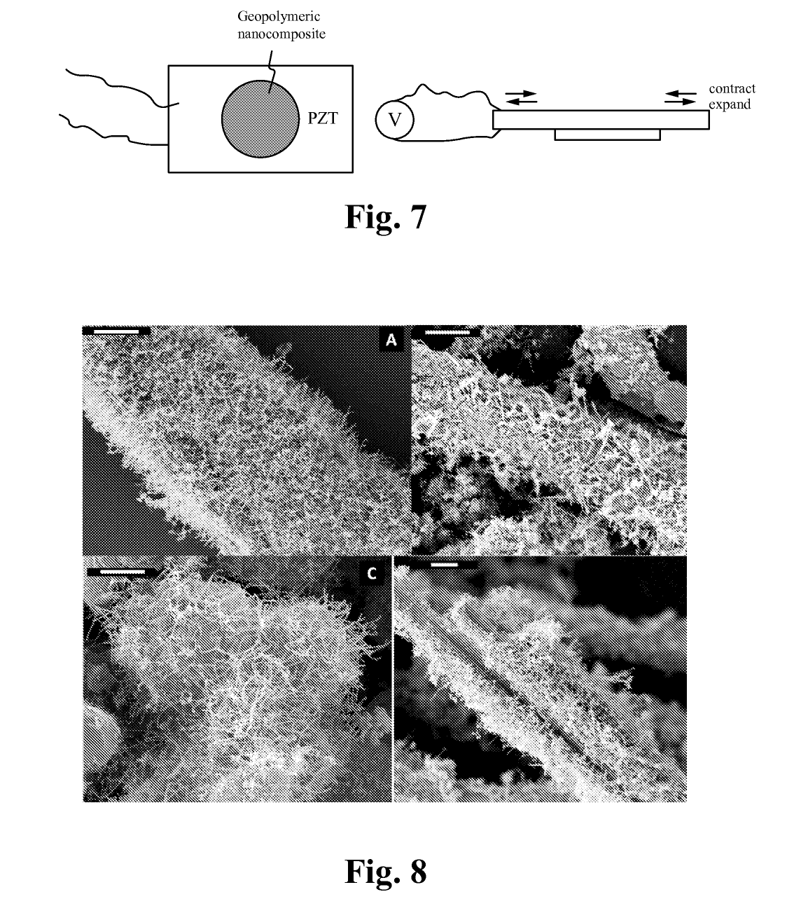

These CNT-decorated engineering materials are able to be used as multifunctional fillers into a polymer matrix, or construction materials to build intelligent structures, in order to enhance the electrical and thermal conductivity and mechanical strength. To demonstrate the applicability of this strategy, CNT decorated glass microballoons, as illustrated in Image C of FIG. 8, were used as filler to enhance the mechanical characteristics of epoxy based conventional syntactic foam (SF). The CNT grown amino-silane treated glass microballoons were infused into the low viscosity epoxy resin to make a novel nanocomposite, called nano-syntactic foam (nano-SF). Static fracture studies were carried out for conventional SF and nano-SF, containing 15 vol. % undecorated/decorated microballoons respectively.

The three-point bending tests revealed an enhancement for the nano-SF in terms of critical fracture toughness and cross head displacement at ˜17.0% and ˜7.5%, respectively, compared to conventional SF. To ensure the repeatability of experimental results, three specimens of each composite were tested under identical conditions. The results were repeatable within the error range of ˜4.0%. This finding confirmed that direct growth of CNT will assist the improvement of the mechanical characteristics such as static toughness.

### Experiment #3

### Synthesis of Conductive Polypyrrole Coated Engineering Materials

In a typical experiment, 1 g fly ash (glass fiber, glass balloon or others) is dispersed in 60 mL 1M HCl under magnetically stirring for 10 minutes, pyrrole (0.24 M) was then added into the above dispersed glass fiber/HCl mixture suspension, then stirred for 10 minutes. After that, 0.03 M ammonium peroxydisulfate (APS) was added into the solution mixture and stirring for 4 hours resulting in polypyrrole coated fly ash in the form of dark precipitates. The resulting black precipitate of polypyrrole coated fly ash was suction filtered, washed with copious amounts of aq. 1 M HCl (3×100 mL) and acetone (3×100 mL) and dried under freeze dry for 12 hours. The yield of polypyrrole coated fly ash was ˜1200 mg.

### Experiment #4

Solid State Blending of Conducting Polymer Coated Engineering Materials with Ferrocene

In a typical blending process, polypyrrole coated fly ash (glass fiber, glass balloon or others), ITO nanopowders or polypyrrole powder was blended with same mass amount of ferrocene (100 mg/100 mg) in a 10 mL plastic vial and spinned in speed mixer at the rotation speed of 3500 rpm for 5 minutes.

### Experiment #5

Microwave Assisted of Carbon Nanotubes Ultrafast Growth from Polypyrrole Coated Fly Ash and Ferrocene Mixture Heating

150 mg mixture of polypyrrole coated fly ash (glass fiber, glass microballoon or others) and ferrocene mixture were placed in a glass vial and then heated in a conventional microwave oven for 15 seconds.

### Experiment #6

### Fracture Test Sample Preparation

To demonstrate the applicability of above method, carbon nanotubes were grown on glass microballoons and used as filler to strengthen the mechanical characteristics of epoxy based conventional syntactic foam. The amino-silane (γ-aminopropyltrimethoxysilane) treated glass microballoons (XLD3000, from 3M Corporation, USA; true density 230 kg/m3 and average diameter 30 microns) were employed for this purpose. The carbon nanotube grown microballoons were infused into the low viscosity epoxy (Epo-Thin, from Beuhler Inc., USA; Bisphenol-A resin and Amine based hardener; densities 1130 kg/m3 and 961 kg/m3, respectively) to make a novel nanocomposite, referred to as nano syntactic foam. To carry out the comparative static fracture study, syntactic foam (containing 15% microballoons by volume) and nano syntactic foam (containing equal amount of carbon nanotube grown microballoons as in case of syntactic foam) sheets were cast separately. Cast sheets were machined into test specimens of dimensions 76.2 mm×22.0 mm×8.7 mm. An edge notch of nominal length of 4.4 mm was introduced at mid span of each specimen using a high speed diamond impregnated circular saw. The tip of notch was sharpened using a razor blade.

### Fracture Test and Results

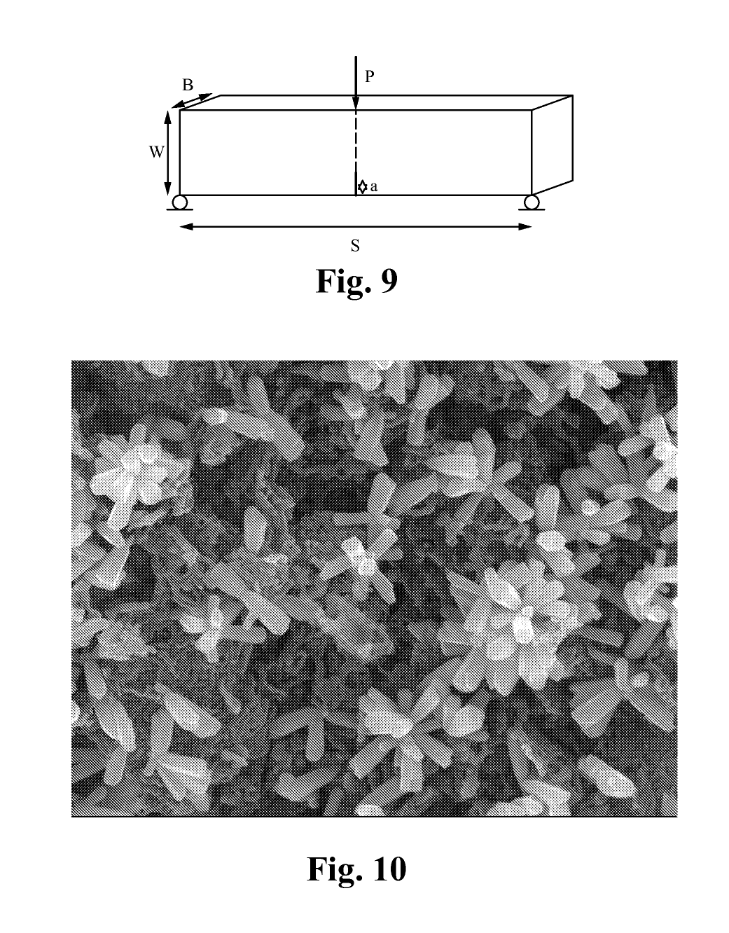

The three-point bending tests were performed at room temperature using Instron 4465 testing machine, under displacement control mode and a crosshead speed of 0.002 mm/sec was maintained during the tests. The load-displacement behavior, as illustrated in FIG. 9, remains linear until fracture, which proposes the failure to be brittle for syntactic as well as nano syntactic foams. The critical fracture toughness (K_{I})_{cr} at failure was computed using the following equation:

$${K}_{I}^{cr} = \frac{{P}_{cr} S}{{BW}^{3 / 2}} [ 2.9 {( \frac{a}{W} )}^{1 / 2} - 4.6 {( \frac{a}{W} )}^{3 / 2} + 21.8 {( \frac{a}{W} )}^{5 / 2} - 37.6 {( \frac{a}{W} )}^{7 / 2} + 38.7 {( \frac{a}{W} )}^{9 / 2} ]$$

where, (K_{I})_{cr} is critical fracture toughness for mode I fracture, P_{cr} is critical load at failure, a is notch length, B is thickness, S is span length and W is Width. The (K_{I})_{cr} values for syntactic and nano syntactic foam are 2.001±0.050 MPa√m (at ultimate cross head displacement of 0.554±0.024 mm) and 2.346±0.064 MPa√m (at ultimate cross head displacement of 0.595±0.030 mm) respectively. The introduction of carbon nanotube grown microballoons enhanced the critical fracture toughness and cross head displacement at fracture by ˜17.0% and ˜7.5%, respectively, compared to syntactic foam. To ensure the repeatability of experimental results, three specimens of each composite were tested under identical conditions. The results were repeatable within the error range of ˜4.0%.

In some embodiments, instead of growing CNTs, metal oxides are grown, including, but not limited to, Titanium Oxide, Zinc Oxide or Silicon Oxide. A similar process to that described herein for growing CNTs is used to grow a metal oxide. FIG. 10 illustrates an image of Zinc Oxide crystals according to some embodiments. In some embodiments, a different precursor such as zinc chloride is used for growing the metal oxides.

To utilize the nanocomposite, the nanocomposite is applied in any manner appropriate such as forming the nanocomposite into structures or applied to an existing structure. The nanocomposite is used in the same manner that cement or other building materials are used, for example, in making buildings, bridges and other structures. In production, the nanocomposite is able to be generated, stress tested and studied in various ways, using the implementations described.

In operation, the nanocomposite will generate significant social, economic and environmental benefits. By having high tensile strength and high toughness, a large number of opportunities of applying fly ashes are opened up. Besides replacing OPC, the nanocomposite is able to be used as an inorganic adhesive/resin to make fiber reinforced inorganic composites. The composite is fire resistant and has no volatile organic compounds. Due to its multifunctional character, the nanocomposite is able to be used as a sensing element in intelligent structures, corrosion protection coating for concrete and steel structures and even electronic devices. Besides the construction industry, many other industries, such as aerospace and automotive, are also able to benefit by using the nanocomposite.

Coating CNTs on fly ash particles is able to be used to process Portland cement, carbon fibers, glass fibers or steel fibers. These nano-engineered particles or fibers are able to be used to manufacture new composites which will possess superior properties and find many application opportunities in infrastructure.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

1. A method of generating a nanocomposite comprising:
a. coating a material with conducting polymers;
b. coating the resultant material coated with conducting polymers with a catalyst precursor; and
c. performing irradiation to generate carbon nanotubes on the material to form a nanocomposite.

2. The method of claim 1 wherein the irradiation is microwave irradiation.

3. The method of claim 1 wherein the material is selected from the group consisting of fly ash particles, ordinary Portland cement, metakaolin, micron-sized glass balls and ground tire rubber particles, slag particles, glass fibers, carbon fibers, Kevlar fibers and Basalt fibers.

4. The method of claim 1 wherein the catalyst precursor is ferrocene.

5. The method of claim 1 wherein poptube precursors are prepared by decorating the catalyst precursor on stand-alone conductive materials or conductive materials-coated engineering materials.

6. The method of claim 5 wherein the stand-alone conductive materials comprise carbon fibers.

7. The method of claim 5 wherein the engineering materials are selected from the group consisting of ITO powders and polypyrrole.Cl powder, polypyrrole.Cl coated fly ash powders, glass fibers, Kevlar, Basalt fibers, and microballoons.

8. The method of claim 1 wherein performing irradiation takes 5-15 seconds.

9. The method of claim 1 wherein performing irradiation occurs at ambient temperature.

10. The method of claim 1 wherein the nanocomposite is filled in a polymer matrix.

11. A method of generating a nanocomposite comprising:
a. blending fly ash particles coated with carbon nanotubes with fly ash particles without carbon nanotubes to form a blended source material;
b. mixing the blended source material with an alkaline activator which results in a nanocomposite; and
c. molding the nanocomposite into a desired shape.

12. The method of claim 11 further comprising coating the fly ash particles with the carbon nanotubes to form coated fly ash particles.

13. A method of generating carbon nanotubes comprising:
a. decorating a catalyst precursor on conductive materials; and
b. heating the decorated catalyst precursor and the conductive materials, wherein the catalyst precursor decomposes to an iron catalyst and cyclopentadienyl which serves as a carbon source.

14. The method of claim 13 wherein heating comprises microwave irradiation.

15. The method of claim 13 wherein heating includes heating to a temperature above 1100° C.

16. The method of claim 13 wherein the catalyst precursor is a metallocene.

17. The method of claim 13 wherein the catalyst precursor is ferrocene.

18. The method of claim 13 wherein the conductive materials are coated with a nanocomposite.

19. The method of claim 13 wherein the carbon source is used to generate carbon nanotubes.

20. A method of generating carbon nanotubes comprising:
a. positioning a precursor;
b. mixing a conductive polymer with the precursor; and
c. microwave irradiating the precursor and the conductive polymer mixture to generate carbon nanotubes.

21. The method of claim 20 wherein the conductive polymer is selected from the group consisting of conductive polypyrrole.Cl powder or film and ITO nanopowder.

22. The method of claim 20 wherein microwave irradiating takes 5-15 seconds.

23. The method of claim 20 wherein microwave irradiating occurs at ambient temperature.

24. A method of generating a nanocomposite comprising:
a. coating particles with conducting polymers;
b. coating the resultant particles coated with conducting polymers with a catalyst precursor; and
c. performing irradiation to generate a metal oxide on the particles to form a nanocomposite.

25. The method of claim 24 wherein the irradiation is microwave irradiation.

26. The method of claim 24 wherein the particles are selected from the group consisting of fly ash, ordinary Portland cement, metakaolin, micron-sized glass balls and ground tire rubber particles, slag particles, glass fibers, carbon fibers, Kevlar fibers and Basalt fibers.

27. The method of claim 24 wherein the catalyst precursor is zinc chloride.

28. The method of claim 24 wherein performing irradiation takes 5-15 seconds.

29. The method of claim 24 wherein performing irradiation occurs at ambient temperature.

30. The method of claim 24 wherein the nanocomposite is filled in a polymer matrix.

31. The method of claim 24 wherein the metal oxide is selected from the group consisting of Titanium Oxide, Zinc Oxide or Silicon Oxide.
